(19) United States
(12) Patent Application Publication
(10) Pub. No.: US 2006/0164044 A1
(43) Pub. Date: Jul. 27, 2006

(54) Digital pulse controlled capacitor charging circuit

(76) Inventors: Cheong Siong Keat, Singapore (SG); Chng Hooi Yong, Singapore (SG)

Correspondence Address: CHRISTIE, PARKER & HALE, LLP, PO BOX 7068, PASADENA, CA, 91109-7068, US

(21) Appl. No.: 11/042,028

(22) Filed: Jan. 25, 2005

(51) Int. Cl. H02J 7/00

(52) U.S. Cl. 320/166

(57) ABSTRACT

A method for charging a capacitor charging circuit comprises producing a digital pulse train, converting the digital pulse train to an AC signal, amplifying the AC signal to produce a high voltage AC signal, rectifying the high voltage AC signal to produce a capacitor charging signal, sampling characteristic data from the capacitor charging circuit, optimizing the digital pulse train based on the characteristic data, and charging the capacitor using the capacitor charging signal. The digital pulse train may be continually optimized based on the characteristic data.

### FIELD OF THE INVENTION

The present invention relates to a circuit and method for charging and storing a high voltage used with a camera flash.

### BACKGROUND

As cell phones and other portable electronic devices grow in complexity, manufacturers strive to include ever greater functionality in these devices to attract customers. Recently, small digital cameras have been included with some cellular telephones. However, these cameras are not always used in situations where a sufficient amount of natural light is present to ensure a well exposed picture is taken. Electronic flashes are a simple and cheap method of providing proper lighting for photographic applications where the amount of natural light is limited. However, the inclusion of electronic flashes in portable electronic devices has been hampered by the bulk and complexity of these flashes. As such, there is a need for smaller, more compact flash systems for use with portable devices.

As is known to one skilled in the art, conventional flash circuits are made using a number of discrete components including multiple resistors, capacitors and inductors, among others. These analog components may be used for the charging of a storage capacitor. In addition to these components, flyback transformer circuits may be used to charge a storage capacitor for a flash circuit using a series of pulses of primary current to a flyback transformer. However, due to incomplete energy depletion of the secondary windings of the flyback transformer during discharge, as well as the transient amount of current necessary to charge empty discrete components in the circuit upon start-up, the phenomenon known as inrush current arises. Those skilled in the art will be familiar with the phenomenon and know that it is undesirable from a performance standpoint. Therefore, in addition to the need for smaller, more compact flash systems, there is an additional need for a system which can be charged quickly and efficiently while experiencing a minimum of inrush current.

### SUMMARY OF THE INVENTION

In one embodiment, a method for charging a capacitor charging circuit comprises producing a digital pulse train, converting the digital pulse train to an AC signal, amplifying the AC signal to produce a high voltage AC signal, rectifying the high voltage AC signal to produce a capacitor charging signal, sampling characteristic data from the capacitor charging circuit, optimizing the digital pulse train based on the characteristic data, and charging the capacitor using the capacitor charging signal. The digital pulse train may be continually optimized based on the characteristic data.

In another embodiment, a portable electronic device comprises a cellular telephone, a primary power source connected to the cellular telephone, a transformer connected to the primary power source for boosting voltage provided by the primary power source, a diode connected to the transformer for rectifying fluctuating current provided by the transformer, a capacitor connected to the diode for storing charge, a microcontroller providing an output according to a stored program, and an electronic switch coupled to the microcontroller for drawing power through the transformer.

In an alternative embodiment, the flash converter circuit further comprises a feedback loop coupling the output of the diode to the microcontroller. The stored program varies the output provided by the microcontroller in response to changes in the signal on the feedback loop.

In another alternative embodiment, the flash converter circuit further comprises a feedback loop coupling the output of the diode to the microcontroller. The stored program operates to dynamically vary at least one of the charging frequency and duty cycle of the output provided by the microcontroller according to a received signal to optimize a performance characteristic of the flash converter circuit. The charging speed of the flash converter circuit, as well as the incidence of inrush current in the flash converter circuit are both performance characteristics which may be optimized in various embodiments of the present invention.

In yet another embodiment of the present invention, a microcontroller included as a processor for a consumer device may be used to generate a series of digital pulses with which to drive a transformer, which in turn is used to store a high voltage charge on a capacitor. The microcontroller may be used to produce all manner of dynamic signals from a basic square wave to more complex methods of adaptive pulse shaping. It will be known to one skilled in the art to select the optimum waveform based on the requirements of the application at hand.

By using a microcontroller already present in a device, such as the microcontroller native to a cellphone or the like rather than using discrete components to generate a series of digital pulses, the size of the circuit for charging a capacitor including the printed circuit board and the number of components used thereon will therefore be reduced in one embodiment of the present invention while a fast charging time is maintained.

It is estimated that the exemplary embodiment of the present invention could be at least 10% smaller in size and concomitantly cheaper than conventional flash module converter circuits while maintaining its performance (e.g. speed of charging). This is especially desirable where a miniature flash module is packed into compact devices such as with a mobile phone camera and other such portable devices.

### BRIEF DESCRIPTION OF THE DRAWINGS

FIG. 1 shows a known camera flash charging circuit;

FIG. 2 shows a camera flash charging circuit according to an exemplary embodiment of the present invention;

FIG. 3 shows a flowchart according to which a digital pulse signal may be provided by a microcontroller in one embodiment of the present invention;

FIGS. 4a, 4b show a pair of oscilloscope readouts for the voltage level and the current drain characteristics of one embodiment of the present invention;

FIGS. 5a, 5b show a pair of oscilloscope readouts for the voltage level and the current drain characteristics of another embodiment of the present invention;

FIGS. 6a, 6b show a pair of oscilloscope readouts for the voltage level and the current drain characteristics of another embodiment of the present invention;

FIGS. 7a, 7b show a pair of oscilloscope readouts for the voltage level and the current drain characteristics of yet another embodiment of the present invention;

FIG. 8 shows a top view of the camera flash charging circuit of FIG. 2;

FIG. 9 shows a bottom view of the camera flash charging circuit of FIG. 2;

FIG. 10 shows a oblique view of the camera flash charging circuit of FIG. 2; and

FIG. 11 shows a side view of the camera flash charging circuit of FIG. 2 being tested.

Before any embodiment of the invention is explained in detail, it is to be understood that the invention is not limited in its application to the details of construction and arrangements of components set forth in the following description, or illustrated in the drawings. The invention is capable of alternative embodiments and of being practiced or being carried out in various ways. Also, it is to be understood that the terminology used herein is for the purpose of illustrative description and should not be regarded as limiting.

### DETAILED DESCRIPTION OF THE INVENTION

A basic camera flash system has three major parts: a small battery, which serves as the power supply, a gas discharge tube which actually produces the flash, and a circuit normally made up of a number of discrete components. The discharge tube usually consists of a tube filled with xenon gas, with electrodes on either end and a trigger electrode which can be metal or an electrically conductive layer at the body of the tube. Because of the high voltage needed to ionize the gas of the discharge tube and create a flash, the flash circuit needs to boost the voltage from the battery substantially before it may be successfully applied to the discharge tube.

Traditionally, forward-type converters have been used for booster circuits in conventional electronic flash apparatuses because they are simple in structure and are little affected by variations of oscillating transformers. However, as cameras have been made more compact, low-capacity batteries have increasingly been used to provide power for the camera flash. In contrast, high guide numbers are required of the camera flash, necessitating a high intensity flash to properly expose the image. Accordingly, flyback-type converters which are more efficient than forward-type converters are gaining in popularity over traditional forward-type converters. Efficient charging of a capacitor by a low current may be achieved using a flyback converter.

As is known to one skilled in the art, to boost voltage using a flyback converter a fluctuating current is needed, which may be provided in a flash circuit by continually interrupting the DC current flow. Rapid, short pulses of DC current are passed to the flyback transformer from a simple oscillator, continually fluctuating its magnetic field. The oscillator's main elements are the primary and secondary coils of a transformer, another inductor (the feedback coil), and a transistor acting as an electrically controlled switch. The switched DC power is converted to an AC signal at the transformer and as such can be stepped up or down in voltage by the transformer.

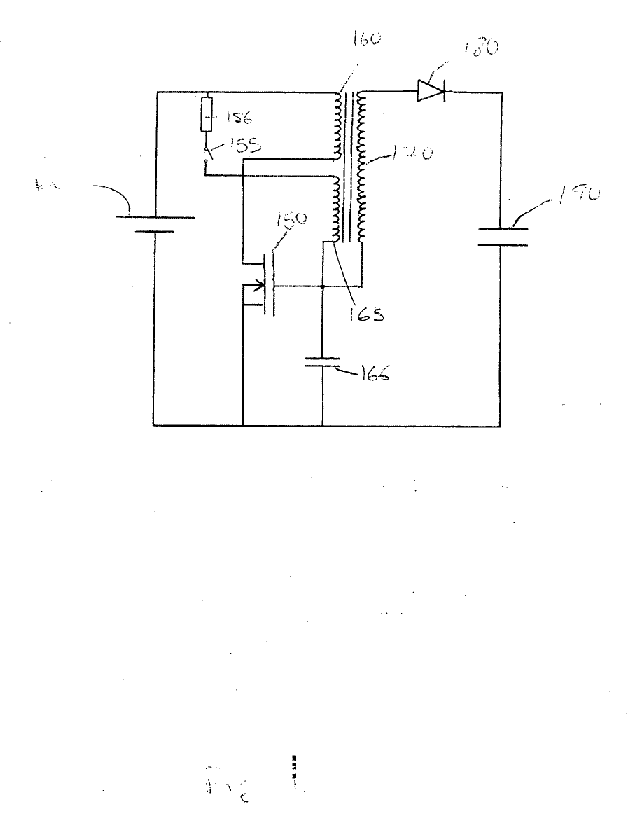

Accordingly, FIG. 1 shows a known camera flash charging circuit using a switch mode power supply for charging a capacitor 190. Stored charge on the capacitor 190 may be later used to activate a photo flash tube (not shown). Generally, switch mode power supplies are used in applications where low DC input must be converted to high DC voltage output to charge a capacitor. Because this requires a transformer, and because the transformer needs a fluctuating power supply to operate, with a switch mode power supply the primary current to the transformer is controlled by a series of on and off switched pulses, thus giving rise to the name. Various means can be employed to control the series of pulses in the primary current feeding the transformer.

The degree to which the transformer steps up or down the voltage between the primary 160 and secondary 170 coils of the transformer depends on the number of loops in each coil and/or the space and materials between the loops (for example, one coil might be wound around the other, or both might be wound around an iron core). In a step-up transformer like the one shown in FIG. 1, the secondary coil 170 will have many more loops than the primary coil 160. As a result, the voltage generated on the secondary coil 170 will be much greater than that present on the primary coil 160.

The charging circuit of FIG. 1 is activated by closure of the charging switch 155, which sends a short burst of current from the power supply 100 through the feedback coil 165 to the base of the transistor 150. Applying this current to the base of the transistor 150 allows current to flow from the collector to the emitter of the transistor 150. When the transistor is “switched on” in this way, a second burst of current can then flow from the power supply 100 to the primary coil 160 of the transformer. This burst causes a change in voltage in the secondary coil 170, which in turn causes a change in voltage in the feedback coil 165. This voltage in the feedback coil 165 conducts current to the transistor base, making the transistor 150 conductive yet again, and the process repeats. As the circuit continually interrupts and repeats itself in this way, voltage is gradually boosted on the secondary coil 170 of the transformer.

The high-voltage output from the transformer is rectified by the rectifier diode 180 from a fluctuating current back into a steady direct current. This high-voltage charge is then used to charge a flash electrolytic capacitor 190. A second transformer (not shown) may be used to further boost the voltage from the capacitor 190 before applying this voltage to a discharge tube (not shown) to produce the flash.

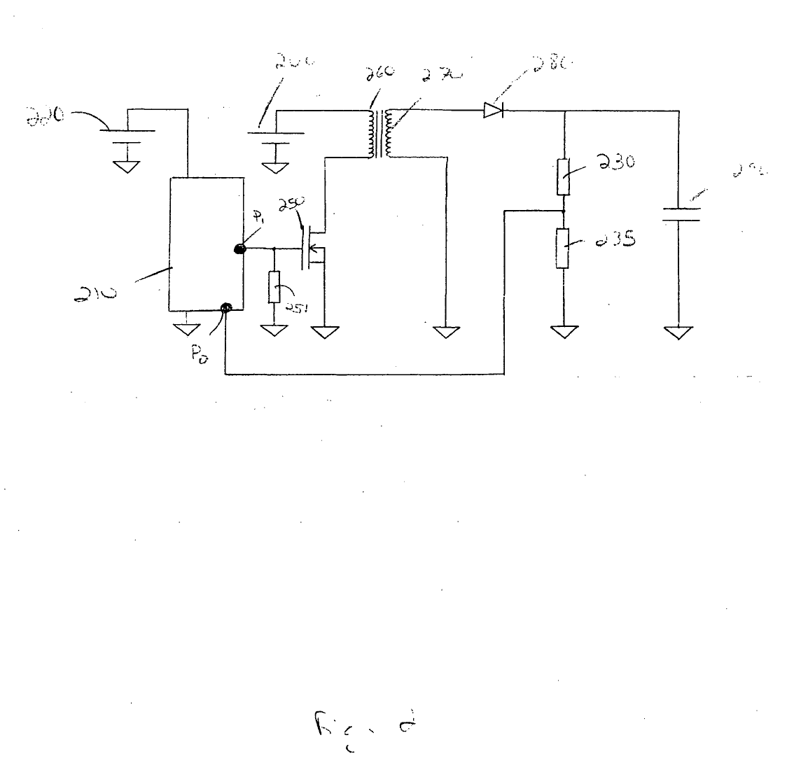

In a novel alternative, an exemplary embodiment according to the present invention is shown in FIG. 2. At the heart of this embodiment lies the microcontroller 210, which is provided to output a dynamic, programmable digital control signal to the flyback converter in the embodiment shown in FIG. 2. Rather than the charging method used in the prior art, this embodiment of the present invention features dynamic pulse charging as a control signal wherein the pulses need not be fixed duty cycle or fixed pulse width. Either of these phenomenon can be independently varied to optimize the charging characteristics of the circuit. In the embodiment shown in FIG. 2, the dynamic pulse charging is provided by the microcontroller 210.

The microcontroller 210 may in one embodiment be a microprocessor also serving other functions in the device with which the capacitor charging circuit is included. For example, were the present circuit included with a cellphone having an onboard digital camera, a microprocessor ordinarily included with the phone to handle telephony and other applications may be made to serve as the microcontroller 210 shown in FIG. 2.

Borrowing the functionality of an already present component in the form of the microcontroller 210 helps reduce the total space needed for the present digital flash converter by eliminating some of the discrete components that would otherwise be necessary in the circuit. Prior art charging circuits featured bulky discrete or analog components.

However, the present capacitor charging circuit uses fewer discrete components, focusing instead on using digital components to produce a pulse train to reduce the total number of components needed overall when compared with a conventional flash circuit. Specifically the need for an LC oscillator circuit is eliminated by harnessing the power of the microcontroller 210 and as such, the size and especially cost for the capacitor charging circuit can be reduced, a factor especially important for portable electronic devices where the size and cost of the devices as a whole are critical constraints.

Furthermore, a greater flexibility is provided for the capacitor charging circuit. Rather than having a control signal the frequency and profile of which is fixed based on the inherent capacitance and inductance values of the discrete components used to produce it (such as the LC oscillator shown by the feedback coil 165 and the capacitor 166 in FIG. 1), a wide range of control signals may be programmed into the microcontroller 210 and activated at will.

These control signals may be dynamically varied during the operation of the charging circuit based on data received by the microcontroller 210 in a feedback loop. The pulse train must be modified based on this feedback received from the circuit to optimize performance characteristics of the charging circuit such as the charging speed and the incidence of inrush current.

In one embodiment, the microcontroller 210 is provided by a BASIC Stamp II microprocessor from Parallax Inc. The BASIC Stamp II microprocessor is an embedded processor having on-board power regulation, program storage, and a BASIC interpreter. The BASIC Stamp II microprocessor has fully programmable I/O pins that can be used to directly interface to a variety of components. The microcontroller 210 is connected to a power supply 220. In one embodiment, this power supply 220 provides a voltage of 5V to the microcontroller 210.

An electronic switch 250 receives control signals from the microcontroller 210 to activate and deactivate the flow of current from the power supply 200 to the primary coil 260. In one embodiment, this electronic switch 250 may comprise a FET, Part No. ZXM61N02F manufactured by Zetex Semiconductors.

The primary coil 260 and secondary coil 270, taken together, comprise a flyback transformer for use with the circuit shown in FIG. 2. In one embodiment, this flyback transformer may be a T-15-063 Tokyo Coil transformer. A power supply 200 is provided for energizing the flyback transformer which in turn charges the capacitor. In one embodiment, this power supply 200 provides a voltage of 3.6V.

A rectifier diode 280, also known as a flyback diode when used in the arrangement shown in FIG. 2, is provided attached to the secondary coil 270 of the transformer to rectify the output of the transformer. In one embodiment, this rectifier diode 280 may comprise a surface mount fast recovery rectifier, Part No. SRA9 manufactured by EIC Discrete Semiconductors.

After passing through the rectifier diode 280, the output of the flyback converter is collected by the capacitor 290. This capacitor 290 will ultimately be used to discharge a large voltage to the flash tube of the camera during picture taking by a user of the camera. In one embodiment, the capacitor 290 has a value of 15 μF.

FIG. 2 shows a resistor bridge formed by the resistors 230 and 235, which are connected to the input of the capacitor 290 in the manner shown in FIG. 2. These resistors are used to form a voltage divider which converts and detects the charge level of the capacitor 290, and provides a distinct signal to the input pin P0 of the microcontroller 210 when the voltage at the capacitor 290 reaches 290V. In one embodiment, the resistor 230 has a value of 1 MΩ and the resistor 235 has a value of 4.7 kΩ.

In one embodiment, The microcontroller 210 is configured to use an output provided by pin P1, and an input provided by pin P0. Pin P1 is programmed to provide a pulse train of a certain frequency which can be activated and de-activated. Activation is dependent on the input at pin P0, provided by a voltage divider formed by resistors 230 and 235 which detects the charge level of the capacitor 290. A resistor 251 is used to tie the gate input of the FET 250 to ensure the ground voltage at the gate will not float when there is no signal from pin P1 of the microcontroller 210. In one embodiment, the resistor 251 has a value of 1 kΩ.

Starting with an initially uncharged capacitor 290, the capacitor charging circuit is powered up. The microcontroller 210 determines from the input on pin P0 that the charge level of the capacitor 290 is insufficient, and activates its pulse train via pin P1 to provide an alternating sequence of pulses to the FET 250 which cyclically energizes the flyback transformer and charges the capacitor 290 via the secondary coil 270 of the flyback transformer.

When the capacitor is charged to the desired level, based on the signal present at pin P0, the microcontroller 210 de-activates the pulse train to the FET 250. As long as the circuit is powered, the microcontroller 210 continues to monitor the charge level of the capacitor and activates the pulse train when necessary.

It will be understood by one skilled in the art that various alternatives may be used in place of the components and values specified above. For example, it will be understood that multiple sources are available to generate the pulse train used to charge the capacitor circuit. By way of illustration, any of the following could be used in lieu of the microcontroller 210: a function generator, pulse forming circuit, microprocessor, and a digital signal processor. An ASIC could also be used in lieu of a program run by the microcontroller. However, when a microcontroller is used to generate the pulse train such as with the microcontroller 210 shown in FIG. 2, the microcontroller could be used to control other, distinct functions of the capacitor charging system, such as the synchronization of the flash module and the camera module, resulting in a still more compact circuit needing fewer discrete components.

In addition, the principles of the present invention are not limited to an invention having the values listed above as exemplary embodiments for discrete components. For example, a number of electronics switches will suffice in place of the FET 250 described above from Zetex Semiconductors. For example, a transistor as well as an IGBT can also be used for a similar effect. Likewise the resistances of the resistors 230 and 235 forming the bridge circuit may be altered in the event that it is desirable to charge the capacitor to a level other than 290V.

Furthermore, it will also be understood that the present invention is not limited to the type of converter discussed above. With any flash circuit having a capacitor charged by a transformer energized by an alternating signal, a microcontroller performing other tasks as well in the device may be used to provide the alternating signal. This alternative signal may or may not be amplified between the microcontroller and the transformer. In short, the principles of the present capacitor charging circuit are applicable to any flash charging circuit using a switch mode power supply. One skilled in the art will understand what substitutions and changes may be made to the exemplary embodiment above without straying from the inherent principles of the capacitor charging circuit described herein.

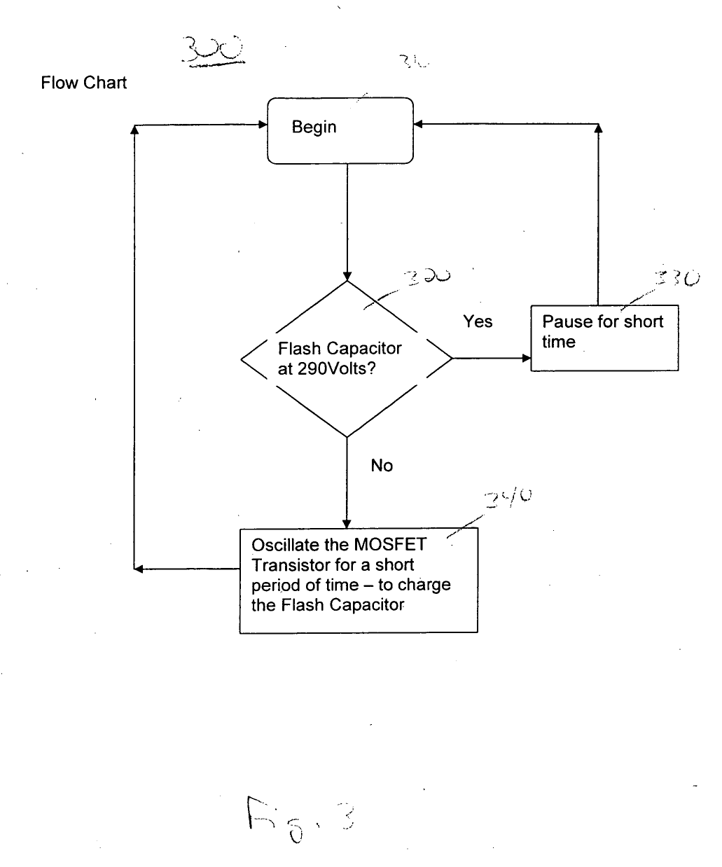

FIG. 3 shows a flowchart 300 according to which a digital pulse signal may be provided by the microcontroller 210 in one embodiment of the present invention. Step 310 begins the process which signifies the powering up of the capacitor charging circuit. In step 320 a determination is made as to whether the capacitor 290 has yet reached the level of 290 volts. This particular value is discussed here in the context of the exemplary embodiments of the values of the discrete components listed above; however, it will be understood by one skilled in the art that 290V is only an exemplary embodiment and other embodiments are possible. This determination is made by the microcontroller 210 receiving an input on pin P0 taken from the voltage divider formed by the resistors 230 and 235 shown in FIG. 2.

If in step 320 the determination is made that the capacitor 290 has reached a level of 290 volts, the process proceeds to step 330 and pauses for a short period of time before returning to step 310 and starting over. If, however, it is determined that the capacitor 290 has not reached this level, then the process proceeds to step 340 wherein the microcontroller 210 proceeds to oscillate the FET 250 for a short period of time to charge the capacitor 290.

This process may be accomplished using code stored on the microcontroller 210. As discussed above, the microcontroller 210 is in one embodiment a Stamp II microprocessor capable of running programs written in the BASIC language. One such program designed to execute the process diagrammed in FIG. 3 is reproduced below:

| ′{$STAMP BS2} | |
|---|---|
| btnWk | VAR Byte |

btnWk = 0 ′Button Workspace Initialization′
DIR0 = 0 ′pin 0 is input
DIR1 = 1 ′pin 1 is OUTPUT
DIR2 = 1 ′pin 2 is OUTPUT
DIR3 = 1 ′pin 3 is OUTPUT
DIR4 = 1 ′pin 4 is OUTPUT
DIR5 = 1 ′pin 5 is OUTPUT
DIR6 = 1 ′pin 6 is OUTPUT
DIR7 = 1 ′pin 7 is OUTPUT
DIRH = %11111111 ′set pin 8-15 as outputs
Loop:
BUTTON 0, 1, 0, 0, btnWk, 1, Charged
FREQOUT 1, 1000, 32767
GOTO loop
Charged:
PAUSE 1 ′pause 1 milli sec
GOTO loop

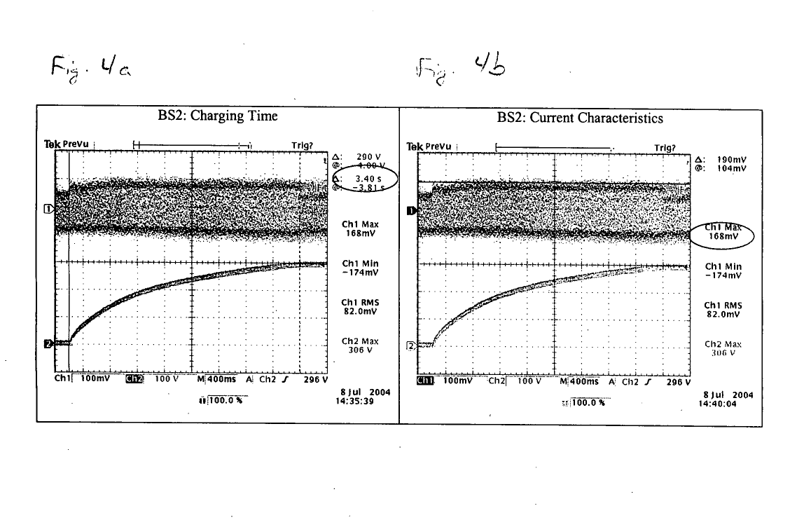

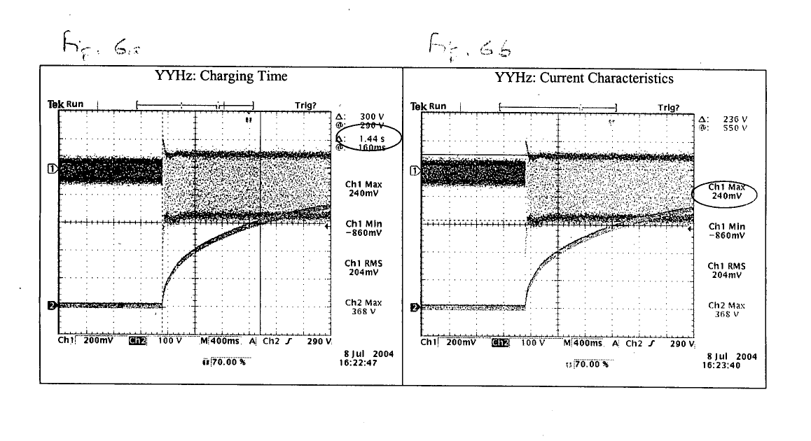

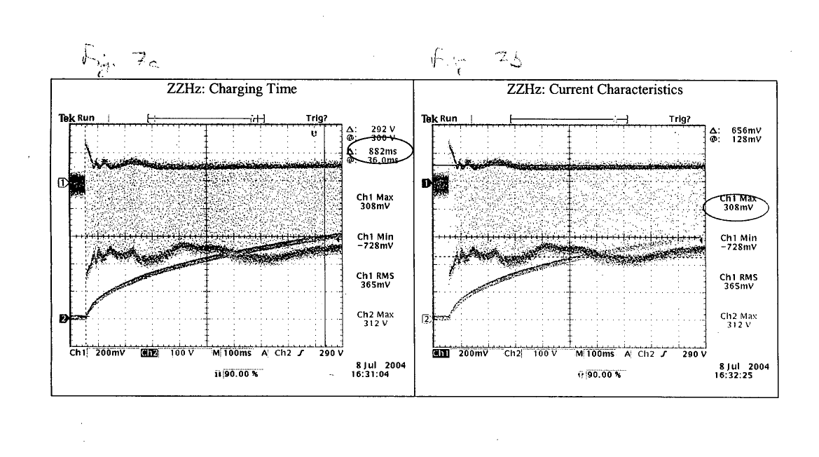

FIGS. 4 through 7 show oscilloscope readouts capturing the performances of various embodiments of the present capacitor charging circuit. Each of the FIGS. 4 through 7 include a pair of readouts A and B. Readout A highlights the voltage level of the capacitor 290 shown in FIG. 2. This voltage level is shown highlighted in channel 2 of the figures. Readout B on the other hand, from each of these pairs of figures, highlights the current drain characteristics from the power supply 200 shown in FIG. 2. These current drain characteristics are shown highlighted in channel 1 of the figures. In order to monitor the current characteristics, a small series “sense” resistor was used. The value of this resistor was 0.1 Ω. Therefore, as an example, an observed voltage of 100 mV would imply 1A.

Both the frequency and duty cycle of the fluctuating signal to the FET 250 may be used as initial sets of input parameters for the circuit. Likewise, the magnitude, duration and RMS value of the peak current during charging of the capacitor 290 may be used as key characteristics defining performance of the charging circuit. According to an exemplary embodiment of the present invention, the charging speed and inrush current of the circuit may be optimized by varying the charging frequency and duty cycle of the output produced by the microcontroller 210.

In a preferred embodiment, this optimization is directed to maximizing the charging speed, shown in FIGS. 4 through 7 as the slope of the voltage level shown in the second channel, while minimizing the incidence of inrush current, shown in FIGS. 4 through 7 as the maximum height of the spike shown in the current drain characteristics highlighted in the first channel. While there is some inherent tradeoff between a fast charging speed and the magnitude of the inrush current phenomenon, use of a microcontroller 210 to produce the pulse waveform driving the present capacitor charging circuit allows the input parameters which effect these performance characteristics to be easily and effectively modified to produce the optimum performance characteristics for the circuit. Furthermore, this optimization may be carried out dynamically by the microcontroller 210 during the charging operation based on feedback received from the circuit.

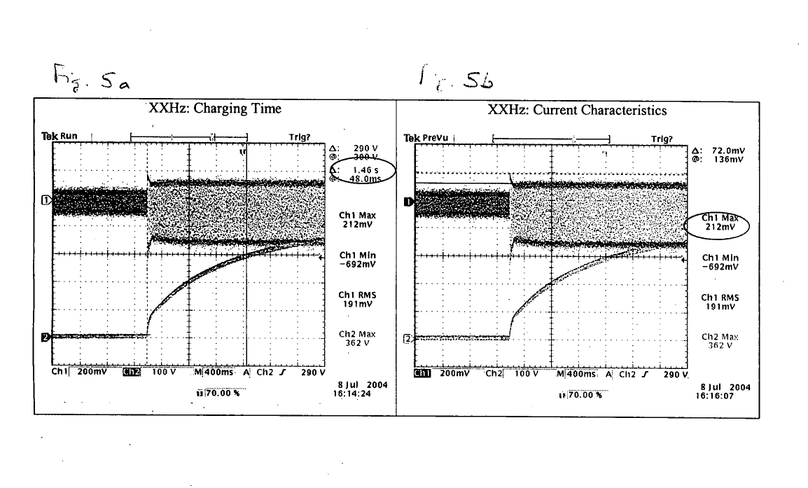

Taken together, FIGS. 4 through 7 demonstrate the relationship between input parameters for the capacitor charging circuit and their resulting impact on the characteristics of the circuit for various embodiments of the present capacitor charging circuit. FIG. 4 for example, shows the results obtained using the exemplary embodiments of the values listed above for the discrete components of the present circuit and the program listed above with the microcontroller 210. FIGS. 5, 6 and 7 show the range of results which may be obtained by modifying these parameters, namely the charging frequency and duty cycle of the output produced by the microcontroller 210.

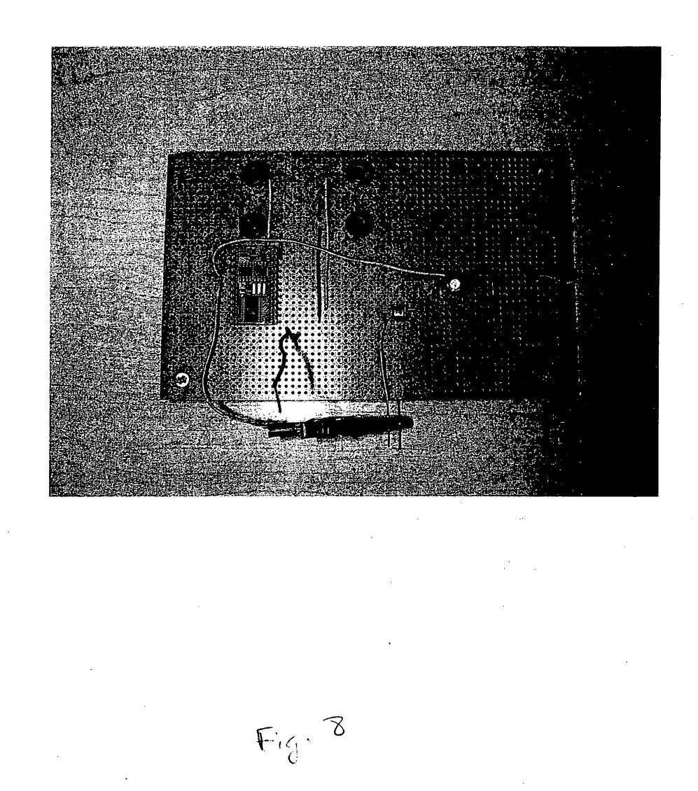

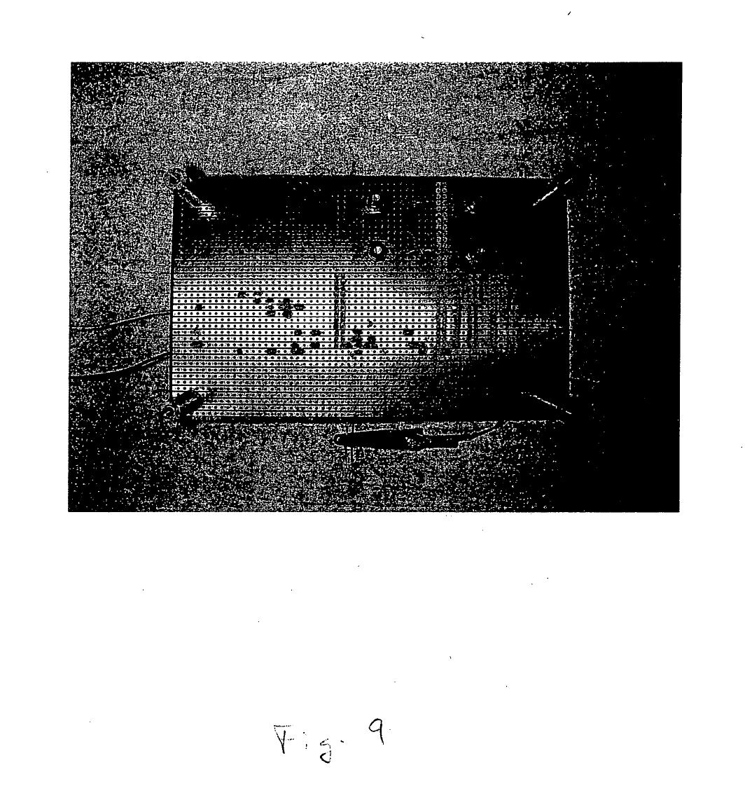

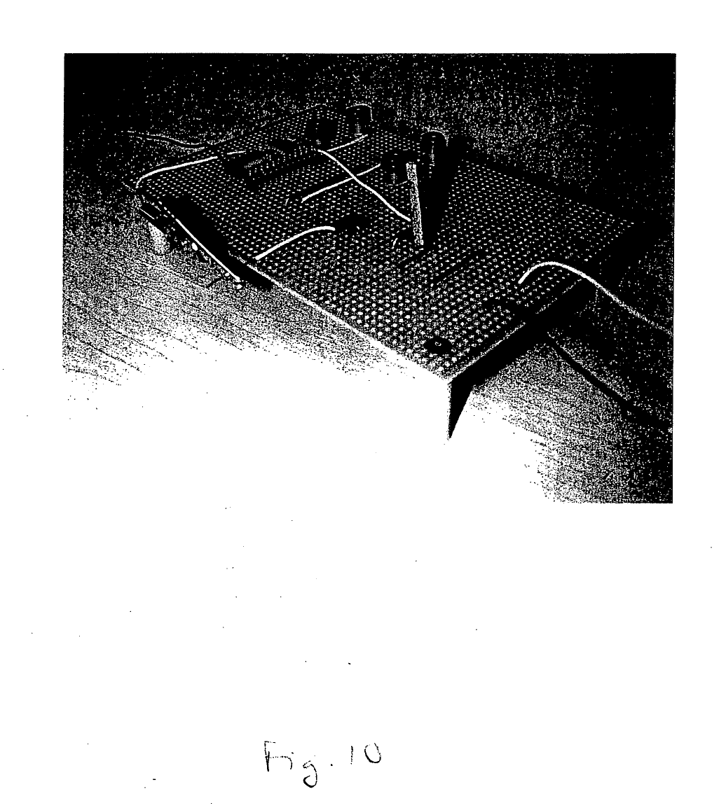

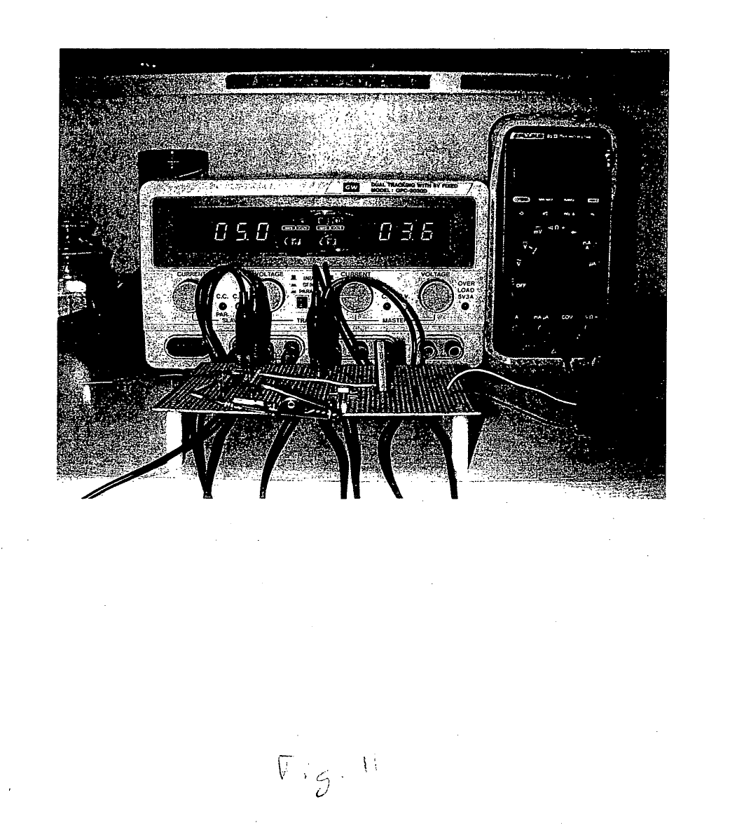

Lastly, as to the remaining figures, FIGS. 8, 9 and 10 show a top, bottom and oblique view of the camera flash charging circuit of FIG. 2 respectively. FIG. 11 shows a side view of the camera flash charging circuit of FIG. 2 being tested.

What is claimed is:

1. A method. for charging a capacitor charging circuit comprising:
producing a digital pulse train;
converting the digital pulse train to an AC signal;
amplifying the AC signal to produce a high voltage AC signal;
rectifying the high voltage AC signal to produce a capacitor charging signal;
sampling characteristic data from the capacitor charging circuit;
optimizing the digital pulse train based on the characteristic data; and
charging the capacitor using the capacitor charging signal.

2. The method of claim 1, wherein the digital pulse train is continually optimized based on the characteristic data.

3. The method of claim 1, wherein the characteristic data comprises a maximum speed at which the capacitor can be charged.

4. The method of claim 1, wherein the characteristic data comprises an incidence of inrush current affecting the capacitor.

5. The method of claim 1, wherein the digital pulse train is produced using a programmable microcontroller.

6. The method of claim 1, further comprising producing a digital pulse train having a variable and nonperiodic pulse width.

7. The method of claim 1, further comprising producing a digital pulse train having a variable and nonperiodic duty cycle.

8. The method of claim 5, wherein the microcontroller synchronizes the capacitor charging circuit and a camera module.

9. The method of claim 1, wherein the digital pulse train is produced using a digital signal processor.

10. The method of claim 1, wherein the digital pulse train is produced using an application specific integrated circuit.

11. A portable electronic device comprising:
a cellular telephone;
a primary power source connected to the cellular telephone;
a transformer connected to the primary power source for boosting voltage provided by the primary power source;
a diode connected to the transformer for rectifying fluctuating current provided by the transformer;
a capacitor connected to the diode for storing charge;
a microcontroller providing an output according to a stored program; and
an electronic switch coupled to the microcontroller for drawing power through the transformer.

12. The flash converter circuit of claim 11, further comprising a feedback loop coupling the output of the diode to the microcontroller, wherein the stored program varies the output provided by the microcontroller in response to changes in the signal on the feedback loop.

13. The flash converter circuit of claim 11, further comprising a feedback loop coupling the output of the diode to the microcontroller, wherein the stored program operates to dynamically vary the output provided by the microcontroller according to a received signal to optimize a performance characteristic of the flash converter circuit.

14. The flash converter circuit of claim 13, wherein charging speed of the flash converter circuit is a performance characteristic of the flash converter circuit.

15. The flash converter circuit of claim 13, wherein incidence of inrush current in the flash converter circuit is a performance characteristic of the flash converter circuit.

16. The flash converter circuit of claim 11, wherein the microcontroller produces a digital pulse train to apply to the electronic switch.

17. The flash converter circuit of claim 16, wherein the microcontroller produces a digital pulse train having a variable and nonperiodic pulse width.

18. The flash converter circuit of claim 16, wherein the microcontroller produces a digital pulse train having a variable and nonperiodic duty cycle.

19. The flash converter circuit of claim 18, further comprising a camera module, and wherein the microcontroller synchronizes the flash converter circuit and the camera module.
